(19) United States
(12) Patent Application Publication
(10) Pub. No.: US 2025/0175818 A1
(43) Pub. Date: May 29, 2025

(54) OVERSHOOTER DETECTION IN A RADIO NETWORK

(71) Applicant: Elisa Oyj, Helsinki (FI)

(72) Inventors: Karri SUNILA, Helsinki (FI); Veijo HÖYKINPURO, Helsinki (FI)

(21) Appl. No.: 18/870,742

(22) PCT Filed: May 24, 2023
(86) PCT No.: PCT/FI2023/050288

§ 371 Date: Dec. 2, 2024

(30) Foreign Application Priority Data
Jun. 2, 2022 (FI) 20225483

(51) Int. Cl. H04W 24/02; H04W 16/28; H04W 56/00; H04W 64/00

(52) U.S. Cl. CPC H04W 24/02; H04W 16/28; H04W 56/0045; H04W 64/00

(57) ABSTRACT

The present disclosure generally relates to detection of overshooting cells in a radio network. Disclosed herein is a computer-implemented method that may include: estimating a dominance area of a cell of a communication network; identifying a plurality of devices transferring data via the cell, wherein the plurality of devices are substantially stationary outside the dominance area of the cell and primarily use at least one other cell of the communication network for data transfer; and determining that the cell is overshooting based on at least one of: a number of the plurality of devices, distances of the plurality of devices to an access node of the cell, or a number of intervening cells overlapping in frequency with the cell and being located between the access node of the cell and the plurality of devices.

### CROSS-REFERENCE TO RELATED APPLICATION

This application is a National Phase entry of International Application No. PCT/FI2023/050288 under § 371 and claims the benefit of Finnish Patent Application No. FI20225483, filed Jun. 2, 2022, which is hereby incorporated by reference in its entirety.

### FIELD OF THE DISCLOSURE

The present disclosure generally relates to the field of wireless communications. Some example embodiments relate to detection of overshooting cells in a wireless communication network.

### BACKGROUND

Wireless communication may be implemented with a cellular radio

network comprising transmission sites that offer communication services via multiple cells corresponding to certain geographical coverage areas. Because of free propagation of radio signals, coverage areas of cells may overlap and therefore signals from different transmission sites may cause interference.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Example embodiments of the present disclosure enable reduction of inter-cell interference within a cellular radio network. This benefit may be achieved by the features of the independent claims. Further example embodiments are provided in the dependent claims, the description, and the drawings.

According to a first aspect, a computer-implemented method is disclosed. The method may comprise: estimating a dominance area of a cell of a communication network; identifying a plurality of devices transferring data via the cell, wherein the plurality of devices are substantially stationary outside the dominance area of the cell and primarily use at least one other cell of the communication network for data transfer; and determining that the cell is overshooting based on at least one of: a number of the plurality of devices, distances of the plurality of devices to an access node of the cell, or a number of intervening cells overlapping in frequency with the cell and being located between the access node of the cell and the plurality of devices.

According to an example embodiment of the first aspect, the method may comprise: determining that the cell is overshooting, if the number of the plurality of devices exceeds a first threshold.

According to an example embodiment of the first aspect, the method may comprise: determining that the cell is overshooting, if a scaled number of the plurality of devices exceeds a second threshold, wherein the number of the plurality of devices is scaled based on distances of the plurality of devices to the access node of the cell.

According to an example embodiment of the first aspect, the method may comprise: determining that the cell is overshooting, if a number of the intervening cells exceeds a third threshold.

According to an example embodiment of the first aspect, the method may comprise: estimating the dominance area of the cell based on a radio propagation model configured to take as input: a location of the access node of the cell and a location of at least one access node of the at least one other cell, and/or an antenna direction of the access node of the cell and at least one antenna direction of the at least one access node of the at least one other cell.

According to an example embodiment of the first aspect, estimating the dominance area may comprise estimating a distance and/or a direction of a border of the dominance area from the access node of the cell.

According to an example embodiment of the first aspect, the method may comprise: determining that a device is located outside the dominance area of the cell, if the distance of the device from the access node exceeds the distance of the border of the dominance area by at least a margin.

According to an example embodiment of the first aspect, the method may comprise: normalizing the distances of the plurality of devices with the distance of the border of the dominance area from the access node of the cell; and scaling the number of the plurality of devices based on the normalized distances of the plurality of devices.

According to an example embodiment of the first aspect, the method may comprise: limiting the normalized distances to an upper limit before scaling the number of the plurality of devices.

According to an example embodiment of the first aspect, the method may comprise: determining that a device is substantially stationary based on a number of cells accessed by the device during a time period, or stability of at least one timing advance value of the device during the time period.

According to an example embodiment of the first aspect, the method may comprise: retrieving subscriber data of a device; and determining that the device is substantially stationary, if a building identifier associated with a current location of the device corresponds to an address included in the subscriber data.

According to an example embodiment of the first aspect, the method may comprise: in response to determining that the cell is overshooting, remotely adjusting an antenna tilt of the cell or outputting an indication of the cell being overshooting.

According to an example embodiment of the first aspect, the indication of the cell being overshooting may comprise an automated service ticket.

According to a second aspect, an apparatus may comprise means for performing any example embodiment of the method of the first aspect.

According to a third aspect, computer program or a computer program product may comprise program code configured to, when executed by a processor, cause an apparatus at least to perform any example embodiment of the method of the first aspect.

According to a fourth aspect, an apparatus may comprise at least one processor; and at least one memory including computer program code; the at least one memory and the computer code configured to, with the at least one processor, cause the apparatus at least to perform any example embodiment of the method of the first aspect.

Any example embodiment may be combined with one or more other example embodiments. Many of the attendant features will be more readily appreciated as they become better understood by reference to the following detailed description considered in connection with the accompanying drawings.

### BRIEF DESCRIPTION OF THE DRAWINGS

The accompanying drawings, which are included to provide a further understanding of the example embodiments and constitute a part of this specification, illustrate example embodiments and together with the description help to understand the example embodiments. In the drawings:

FIG. 1 illustrates an example of a wireless communication network;

FIG. 2 illustrates an example of an apparatus configured to practice one or more example embodiments;

FIG. 3 illustrates an example of user distribution in case of a non-overshooting cell;

FIG. 4 illustrates an example of user distribution in case of an overshooting cell;

FIG. 5 illustrates an example of intervening cells between a cell and secondary user equipment;

FIG. 6 illustrates an example of a flow chart for overshooter detection; and

FIG. 7 illustrates an example of a method for detecting overshooting cells in a radio network.

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

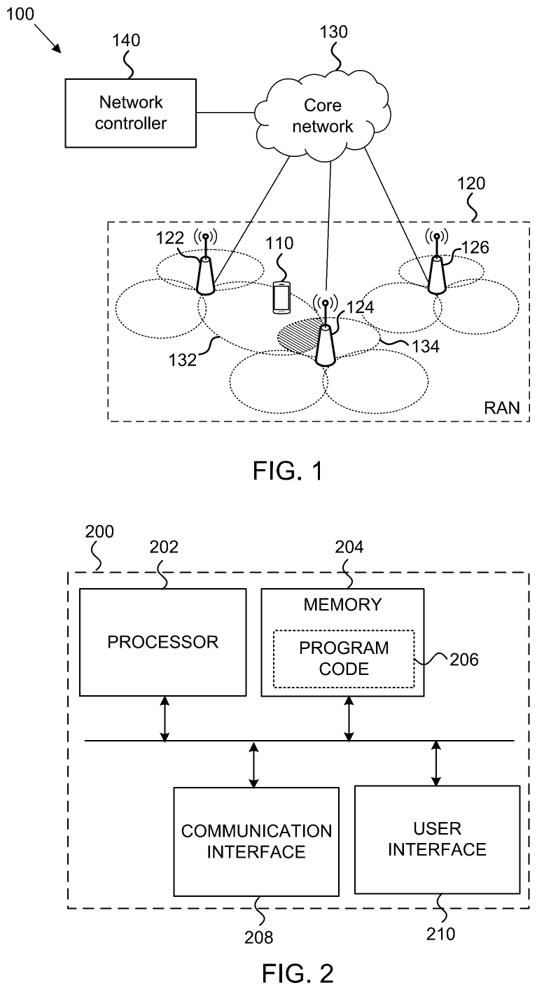

FIG. 1 illustrates an example of a wireless communication network. Communication network 100 may comprise one or more devices, which may be also referred to as client nodes, user nodes, or user equipment (UE). An example of a device is UE 110, which may communicate with one or more access nodes of a radio access network (RAN) 120. An access node may be also referred to as an access point or a base station. Communication network 100 may be configured for example in accordance with the 4^{th} or 5^{th} generation (4G, 5G) digital cellular communication networks, as defined by the 3^{rd} Generation Partnership Project (3GPP). In one example, communication network 100 may operate according to 3GPP (4G) LTE (Long-Term Evolution) or 3GPP 5G NR (New Radio). The wireless communication network may hence comprise a cellular radio network. It is however appreciated that example embodiments presented herein are not limited to these example networks and may be applied in any present or future wireless communication networks, or combinations thereof, for example other type of cellular networks, short-range wireless networks, multicast networks, broadcast networks, or the like. Access nodes 122, 124, 126 of RAN 120 may for example comprise 5^{th} generation access nodes (gNB) or 4^{th} generation access nodes (eNodeB).

An access node may provide communication services within one or more cells, illustrated with dotted circles, which may correspond to geographical area(s) covered by signals transmitted by the access node. Dominance area of a cell may comprise is a physical (geographical) area in which certain cell has the strongest signal level. Handover between cells may be performed when UE 110 is at or near the border of the dominance area. Coverage areas cells may overlap to some extent, for example to facilitate smooth handover for a mobile UE. Serving cell of a UE may be changed when another cell has the strongest signal level. Even though some overlapping may be useful for handover purposes, it may be generally desired to minimize the signal level outside the dominance area. Overshooting may occur for example due to wrong antenna tilting. Excessive overlapping between cells may however cause unnecessary interference and hence degrade performance of the network, for example in terms of achievable data rate.

A cell may be determined to be overshooting, if its signal level remains high also outside its dominance area. It may be desired to effectively detect overshooting cells such that corresponding counteraction(s) (e.g. antenna down tilting) may be performed. In the example of FIG. 1, coverage area of cell 132, served by access node 122, extends near access node 124, thereby causing interference deep within the coverage area of cell 134. Cell 132 may be considered to be overshooting, because its coverage area extends unnecessarily far.

Communication network 100 may further comprise a core network 130, which may comprise various network functions (NF) for establishing, configuring, and controlling data communication sessions of users, for example UE 110. Communication network 100 may further comprise a network controller 140, which may be responsible of configuring various operations of RAN 120 and/or core network 130. Even though illustrated as a separate entity, network controller 140 may be also embodied as part of core network 130. Even though some operations have been described as being performed by network controller 140, it is understood that similar functions may be performed alternatively by other network device(s) or network function(s) of communication network 100. One task of network controller 140 may be to detect overshooting cells, such as cell 132, within RAN 120.

FIG. 2 illustrates an example embodiment of an apparatus 200 configured to perform one or more example embodiments. Apparatus 200 may be for example used to implement network controller 140. Apparatus 200 may comprise at least one processor 202. The at least one processor 202 may comprise, for example, one or more of various processing devices or processor circuitry, such as for example a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

Apparatus 200 may further comprise at least one memory 204. The at least one memory 204 may be configured to store, for example, computer program code or the like, for example operating system software and application software. The at least one memory 204 may comprise one or more volatile memory devices, one or more non-volatile memory devices, and/or a combination thereof. For example, the at least one memory 204 may be embodied as magnetic storage devices (such as hard disk drives, floppy disks, magnetic tapes, etc.), optical magnetic storage devices, or semiconductor memories (such as mask ROM, PROM (programmable ROM), EPROM (erasable PROM), flash ROM, RAM (random access memory), etc.).

Apparatus 200 may further comprise a communication interface 208 configured to enable apparatus 200 to transmit and/or receive information to/from other devices, functions, or entities. In one example, apparatus 200 may use communication interface 208 to transmit or receive information over a service based interface (SBI) message bus of core network 130, for example to core network 130 and/or RAN 120 about detected overshooting cells, to output indication(s) of the detected overshooting cells to a human user or an automated service ticket system, or to provide network configuration instructions (e.g. for remote antenna tilting) to RAN 120 to prevent or reduce overshooting in one or more cells. Apparatus 200 may further comprise a user interface, for example for configuring apparatus 200 or for providing user output by the apparatus, such as for example visual and/or audible signal(s), for example by speaker(s), display(s), light(s), or the like.

When apparatus 200 is configured to implement some functionality, some component and/or components of apparatus 200, such as for example the at least one processor 202 and/or the at least one memory 204, may be configured to implement this functionality. Furthermore, when the at least one processor 202 is configured to implement some functionality, this functionality may be implemented using program code 206 comprised, for example, in the at least one memory 204.

The functionality described herein may be performed, at least in part, by one or more computer program product components such as for example software components. According to an embodiment, the apparatus comprises a processor or processor circuitry, such as for example a microcontroller, configured by the program code when executed to execute the embodiments of the operations and functionality described. A computer program or a computer program product may therefore comprise instructions for causing, when executed, apparatus 200 to perform the method(s) described herein. Alternatively, or in addition, the functionality described herein can be performed, at least in part, by one or more hardware logic components. For example, and without limitation, illustrative types of hardware logic components that can be used include Field-programmable Gate Arrays (FPGAs), application-specific Integrated Circuits (ASICs), application-specific Standard Products (ASSPs), System-on-a-chip systems (SOCs), Complex Programmable Logic Devices (CPLDs), Graphics Processing Units (GPUs).

Apparatus 200 comprises means for performing at least one method described herein. In one example, the means comprises the at least one processor 202, the at least one memory 204 including program code 206 configured to, when executed by the at least one processor, cause the apparatus 200 to perform the method.

Apparatus 200 may comprise a computing device such as for example an access point, a base station, a server, a network device, a network function device, or the like. Although apparatus 200 is illustrated as a single device it is appreciated that, wherever applicable, functions of apparatus 200 may be distributed to a plurality of devices, for example to implement example embodiments as a cloud computing service.

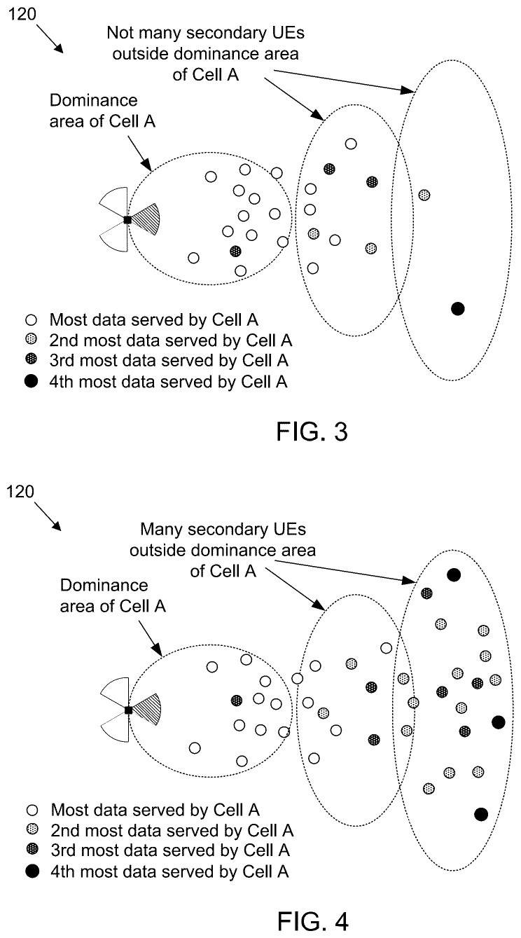

FIG. 3 illustrates an example of user distribution in case of a non-overshooting cell. UEs illustrated with white circles use primarily Cell A for data transfer. Most of the data communicated by these UEs may be therefore served by Cell A. These UEs may be called primary UEs with respect to Cell A. Respectively, Cell A may be a primary cell for these UEs. Majority of the primary UEs of Cell A are located within the dominance area of Cell A. There are however some primary UEs of Cell A outside its dominance area. UEs, for which 2^{nd} most, 3^{rd} most, or 4^{th} most data is served by Cell A, may be called secondary UEs from perspective of Cell A. These UEs may primarily use some other cell for data transfer. Cell A may be therefore a secondary cell for these UEs. Since the number of secondary UEs outside the dominance area of Cell A is low, it may be determined that Cell A is not overshooting. Also the distance of the secondary UEs from the location of the access node (e.g. site of Cell A) may be taken into account. For example, the fact that the secondary UEs located outside the dominance area of Cell A are located relatively near the dominance area of Cell A may be used as an indication that Cell A is not (at least severely) overshooting.

FIG. 4 illustrates an example of user distribution in case of an overshooting cell. In this case, many secondary UEs are located outside the dominance area of Cell A. Furthermore, for many secondary UEs located outside the dominance area of Cell A, the distance from the access node of Cell A is relatively long. Therefore it may be determined that Cell A is overshooting. A transmission site may comprise multiple sectors (e.g. three) and one sector may include one or more cells. If one cell is determined to be overshooting and other cells of the sector use the same antenna(s), it may be determined that the entire sector is overshooting.

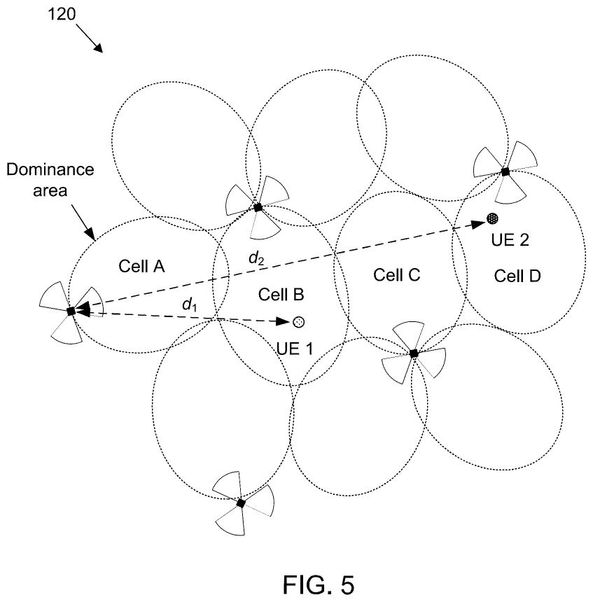

FIG. 5 illustrates an example of intervening cells between a cell and secondary user equipment. UE 1 may be located within dominance area of Cell B and outside of dominance area of Cell A. Distance of UE 1 from the access node of Cell A is d₁, which may be taken into account when determining whether Cell A is overshooting. For example, when calculating the number of secondary UEs located outside the dominance area of Cell A, each user may be given a weight that is dependent on the distance to the access node of Cell A. Weights of multiple UEs may be counted together to obtain a scaled number of the UEs.

A distance-based weight may be calculated similarly to UE 2, located at distance d₂ from the access node of Cell A. However, as illustrated in FIG. 5, there are two cells (Cell B and Cell C) between Cell A and UE 2. Cells overlapping in frequency with the cell and being located between the access node of the analyzed cell (Cell A in this example), may be called intervening cells. Cell B and/or C may have the same frequency range as Cell A, or their frequency ranges may be partially overlapping with the frequency range of Cell A. In this case, the weight of UE 2 may be incremented (e.g. multiplied) based on the number of intervening cells. The existence of at least one intervening cell may be taken as an indication that Cell A is more likely to be overshooting, as will be further described below.

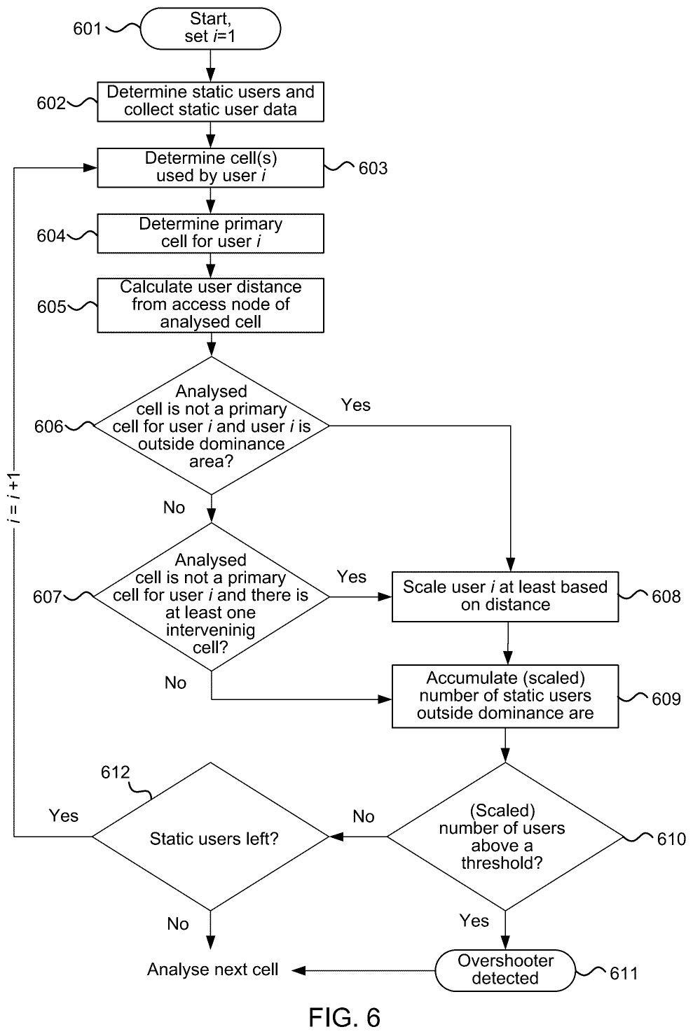

FIG. 6 illustrates an example of a flow chart for overshooter detection. This procedure may be implemented for example by network controller 140 or any other suitable network device, or a combination of network devices. This example procedure iterates over static users of one analyzed cell and determines whether the analyzed cell is overshooting. The procedure may be performed for multiple cells of communication network 100, for example sequentially or in parallel.

At operation 601, the procedure may be started. User loop index i may be set to one. Term ‘user’ is used herein to denote a UE, or in general a device or a terminal.

At operation 602, network controller 140 may determine static users of the cell and collect data of the static users. A static user may be a user that is substantially stationary. A static user may move to some extent (e.g. within a room), but such that movement of the static user does not significantly affect overshooter detection. Network controller 140 may determine a user to be static for example based on number of and/or identities of cells accessed by the user, for example during a time period. For example, if the number of accessed cells (identified e.g. by cell identifiers) meets a condition, for example is below a threshold, network controller 140 may determine the user to be static. Examples of the time period include a day, a certain number of days, a week, etc.

Alternatively, or additionally, stability of timing advance value(s) of the user may be used as a basis for determining whether a user is static. Timing advance may reflect the distance of the user from an access node of the associated cell. For example, if variance of the timing advance (e.g. at the analyzed cell) value is within a range, for example during the time period, network controller 140 may determine that the user is static. It is however also possible to exploit timing advance values of the same user at other cells as well. Using multiple timing advance values may be beneficial, since one timing advance value may indicate only a distance from one access node and not any direction. Using timing advance values from different cells enables determining distances from different access nodes with different angles to the user, thereby enabling more accurate localization of the user. If more than one timing advance value (e.g. associated with different transmission sites) is stable, it is possible to more reliably determine that the user is static.

These two parameters, i.e. number of accessed cells and timing advance value(s), may be also used together, for example such that the user is determined to be static, in response to determining that both conditions are met. Data of a static user may include for example location of the user. Location of the user may be signaled by the user to network controller 140, or network controller 140 may determine user's location by other means.

Network controller 140 may collect subscriber data of users (not only static users), for example in order to determine whether a particular user is static. One example of such subscriber data is the address of the subscriber. For example, if the location of the user matches to an address included in the subscriber data (e.g. home address), network controller 140 may determine that the user is static. In one example, users may be mapped to building identifiers (ID) of map data based on their current location. In this case, network controller 140 may determine that the user is static, if a building ID associated with the current location of the user corresponds to the address included in the subscriber data. The address may be used as an alternative to, or in combination with, the above conditions on the number of accessed cells and/or the stability of the timing advance value(s).

At operation 603, network controller 140 may determine cell(s) used by user i, which may be an i-th user of the set of static users determined at operation 602. The used cells may be determined based on information collected by the core network functions, including for example the amount of data transferred by user i at the different cells and/or the time(s) (e.g. total duration) of transferring data at the different cells.

At operation 604, network controller 140 may determine a primary cell for user i. Network controller 140 may select as the primary cell one of the cells determined at operation 603. The primary cell may be the cell which is primarily used for data transfer by user i, e.g. based on the amount of data transferred and/or the amount of time used for transferring the data.

At operation 605, network controller 140 may calculate distance of user i from the access node of the analyzed cell. This may be based on location information of the transmission site of the analyzed cell and location of the user. Locations may be provided for example in geographical coordinates, from which the distance between different coordinates may be geometrically calculated.

At operation 606, network controller 140 may determine whether the analyzed cell is not a primary cell for user i, in other words, whether user i primarily uses some other cell for data transfer. This may be performed by checking whether analyzed cell was identified as the primary cell at operation 605.

Network controller 140 may determine whether user i is outside the dominance area of the analyzed cell. Network controller 140 may estimate the dominance area of the analyzed cell for example based on a radio propagation model. The radio propagation model may take as input the location of the access node of the analyzed cell and location(s) of access node(s) of other cell(s). Further inputs may include transmission powers of the access nodes, their antenna gains, or the like. Using the location may be sufficient in case of omnidirectional antennas. However, the radio propagation model may also take as input the antenna direction of the access node of the analyzed cell and antenna direction(s) of the access node(s) of the other cell(s).

Dominance areas may be estimated for example based on the free-space path loss model, but it is also possible to use more advanced propagation model(s). Network controller 140 may determine a certain location to belong to the dominance area of a certain cell, if the estimated field strength is highest for that cell, when compared to field strengths of other cells.

Network controller 140 may estimate, based on the radio propagation model, or otherwise, a distance from the access node of the cell to the border of the dominance area. This may be applicable for example in case of omnidirectional radiation pattern. Network controller 140 may additionally determine a direction, for example an angular range, to the border of the dominance area. This may be applicable in case of directive antennas, for example in case of a three-sector implementation of a transmission site. Using the distance to the border of the dominance area, optionally along with the direction, network controller 140 may determine whether the location of the user is outside the dominance area.

In some embodiments, a margin (buffer) may be applied to the distance. In this case, network controller 140 may determine that the user is located outside the dominance area of the analyzed cell, if the distance of the user from the access node exceeds the distance of the border by at least the margin. This enables users located near the border to be excluded from the overshooter detection. This may be beneficial in order to allow some tolerance for estimation of the dominance area. Using the margin enables overshooter detection to be directed to users that are not located near the dominance area and that may be therefore more relevant for overshooter detection.

Network controller 140 may move to execution of operation 607, if the analyzed cell determined be a primary cell for user i, or if user i is not outside the dominance area of the analyzed cell. If the analyzed cell is determined not to be a primary cell for user i and if user i is outside the dominance area, network controller 140 may move to execution of operation 608.

At operation 607, network controller 140 may determine whether the analyzed cell is not a primary cell for user i and whether there is at least one intervening cell between the access node of the analyzed cell and user i. If yes, network controller 140 may move to execution of operation 608. If not, network controller 140 may move to execution of operation 609.

Network controller 140 may determine presence of intervening cell(s) based on the radio propagation model, for example the dominance areas estimated for different cells. Network controller 140 may also determine the number of the intervening cells. This may be based on geometry of the dominance areas of the cells. Intervening cells may have the same frequency (range) as the analyzed cell or they may at least partially overlap in frequency with the analyzed cell.

At operation 608, network controller 140 may scale user i based on its distance from the access node of the analyzed cell. By default, user i may be counted as one user. Scaling may comprise weighting (e.g. multiplying) user i by some weight that is not equal to one, when calculating the number of static users in overshoot detection. Distance of user may be normalized, for example by the distance of the border of the dominance area from the access node of the analyzed cell. Hence, a weight equal to one may be given to users located at the border of the dominance area. Furthermore, a limit may be set for the normalized distance. The limit may be for example equal to two. In this case, users located longer than twice the distance between the access node and the border of the dominance area may be scaled by two. Limiting the scaling enables to control the amount of weighting for distant users and to concentrate the overshoot detection method to users within an intermediate distance from the analyzed cell.

Users may be also scaled based on the number of intervening cells. This scaling may be for example applied on top of the distance-based scaling. Hence, two users located at the same distance may be scaled differently, if there are different number of intervening cells between the analyzed cell and the users.

At operation 609, network controller 140 may accumulate the (scaled) number of users located outside the dominance area with the (scaled) weight of user i. The number of static users may not be accumulated for users located within the dominance area, or, for users for which the analyzed cell is a primary cell.

At operation 610, network controller 140 may determine whether the (scaled) number of users, e.g. the number of static users located outside the dominance area of the analyzed cell and primarily using other cell(s) of the network, is above a threshold. If yes, the analyzed cell may be determined to be overshooting at operation 611. If not, network controller 140 may move to operation 612.

Determining whether the analyzed cell is overshooting may be therefore based on the number of identified users, distances of the identified users, or both. Alternatively, or additionally, determination of whether the analyzed cell is overshooting may be based on the number of intervening cells for the identified users. For example, network controller 140 may determine that the analyzed cell is overshooting, if the number of identified users exceeds a first threshold. Network controller 140 may determine that the analyzed cell is overshooting, if the scaled number of the identified (accumulated) users exceeds a second threshold. As described above, the number of users may be scaled based on their distances to the access node of the analyzed cell. Network controller 140 may determine that the analyzed cell is overshooting, if the number of intervening cells exceeds a third threshold. Network controller 140 may use any suitable combination of these criteria. For example, the analyzed cell may be determined to be overshooting if any two of the thresholds, or all of them, are exceeded.

At operation 612, network controller 140 may determine whether there are static users left for the analyzed cell. If all static users have been considered, network controller 140 may move to analyzing a next cell. If there are still static users to be iterated, network controller 140 may increase the user index i by one and move to execution of operation 603. It is however noted that network controller 140 does not necessarily need to iterate over all static users of the analyzed cell and iterating a subset of them may be sufficient in many situations. Increasing the number of iterated static users may however increase reliability of overshooter detection.

The above procedure results in results in identifying static users (operation 602) that are not primarily using the analyzed cell for data transfer (operation 606) and that are located outside the dominance area of the analyzed cell (operation 606). Network controller 140 may determine whether the analyzed cell is overshooting based on these static users. This overshooter detection method therefore enables to avoid errors caused by moving users.

In response to detecting the analyzed cell to be overshooting at operation 611, network controller 140 may output an indication of the detected overshooting (e.g. visual and/or audible alert signal), transmit an indication of the overshooting to another device, cause performance of a counteraction such as for example remote adjustment of antenna tilt of the analyzed cell (e.g. downwards), and/or issue an automated service ticket for a human user to take care of the overshooting. By efficient detection and enablement of repairing actions, either automatically or manually by a service man, overall network performance may be improved, since unnecessary interference between cells may be effectively avoided.

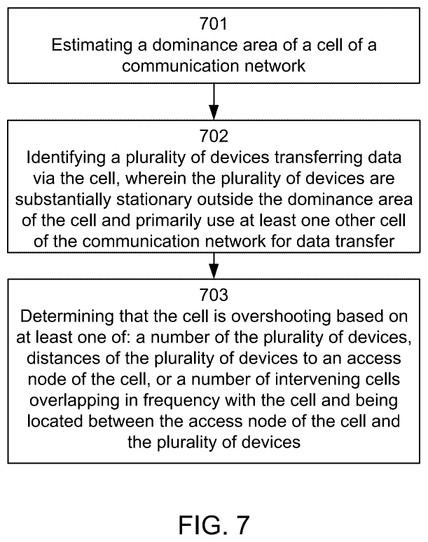

FIG. 7 illustrates an example of a computer-implemented method for overshooter detection in a cellular communication network.

At 701, the method may comprise estimating a dominance area of a cell of a communication network.

At 702, the method may comprise identifying a plurality of devices transferring data via the cell, wherein the plurality of devices are substantially stationary outside the dominance area of the cell and primarily use at least one other cell of the communication network for data transfer.

At 703, the method may comprise determining that the cell is overshooting based on at least one of: a number of the plurality of devices, distances of the plurality of devices to an access node of the cell, or a number of intervening cells overlapping in frequency with the cell and being located between the access node of the cell and the plurality of devices.

Further features of the method directly result for example from the functionalities of network controller 140 or in general apparatus 200, as described throughout the specification and in the appended claims, and are therefore not repeated here. Different variations of the method may be also applied, as described in connection with the various example embodiments.

An apparatus, such as for example a network device configured to implement one or more network functions or entities, may be configured to perform or cause performance of any aspect of the method(s) described herein. Further, a computer program or a computer program product may comprise instructions for causing, when executed, an apparatus to perform any aspect of the method(s) described herein. Further, an apparatus may comprise means for performing any aspect of the method(s) described herein. According to an example embodiment, the means comprises at least one processor, and memory including program code, the at least one processor, and program code configured to, when executed by the at least one processor, cause performance of any aspect of the method(s).

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps or operations of the methods described herein may be carried out in any suitable order, or simultaneously where appropriate. Additionally, individual blocks may be deleted from any of the methods without departing from the scope of the subject matter described herein. Aspects of any of the example embodiments described above may be combined with aspects of any of the other example embodiments described to form further example embodiments without losing the effect sought.

The term ‘comprising’ is used herein to mean including the method, blocks, or elements identified, but that such blocks or elements do not comprise an exclusive list and a method or apparatus may contain additional blocks or elements.

Although subjects may be referred to as ‘first’ or ‘second’ subjects, this does not necessarily indicate any order or importance of the subjects. Instead, such attributes may be used solely for the purpose of making a difference between subjects.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1. A computer-implemented method, comprising:
estimating a dominance area of a cell of a communication network;
identifying a plurality of devices transferring data via the cell, wherein the plurality of devices are substantially stationary outside the dominance area of the cell and primarily use at least one other cell of the communication network for data transfer;
determining that the cell is overshooting based on at least one of:
a number of the plurality of devices,
distances of the plurality of devices to an access node of the cell, or
a number of intervening cells overlapping in frequency with the cell and being located between the access node of the cell and the plurality of devices; and
outputting an indication of the cell being overshooting.

2. The method according to claim 1, further comprising:
determining that the cell is overshooting, if the number of the plurality of devices exceeds a first threshold.

3. The method according to claim 1, further comprising:
determining that the cell is overshooting, if a scaled number of the plurality of devices exceeds a second threshold, wherein the number of the plurality of devices is scaled based on distances of the plurality of devices to the access node of the cell.

4. The method according to claim 1, further comprising:
determining that the cell is overshooting, if a number of the intervening cells exceeds a third threshold.

5. The method according to claim 1, further comprising:
estimating the dominance area of the cell based on a radio propagation model configured to take as input:
a location of the access node of the cell and a location of at least one access node of the at least one other cell, and/or
an antenna direction of the access node of the cell and at least one antenna direction of the at least one access node of the at least one other cell.

6. The method according to claim 5, wherein estimating the dominance area comprises estimating a distance and/or a direction of a border of the dominance area from the access node of the cell.

7. The method according to claim 6, further comprising:
determining that a device is located outside the dominance area of the cell, if the distance of the device from the access node exceeds the distance of the border of the dominance area by at least a margin.

8. The method according to claim 6, further comprising:
normalizing the distances of the plurality of devices with the distance of the border of the dominance area from the access node of the cell; and
scaling the number of the plurality of devices based on the normalized distances of the plurality of devices.

9. The method according to claim 8, further comprising:
limiting the normalized distances to an upper limit before scaling the number of the plurality of devices.

10. The method according to claim 1, further comprising:
determining that a device is substantially stationary based on a number of cells accessed by the device during a time period, or stability of at least one timing advance value of the device during the time period.

11. The method according to claim 1, further comprising:
retrieving subscriber data of a device; and
determining that the device is substantially stationary, if a building identifier associated with a current location of the device corresponds to an address included in the subscriber data.

12. The method according to claim 1, further comprising:
in response to determining that the cell is overshooting, remotely adjusting an antenna tilt of the cell.

13. The method according to claim 12, wherein the indication of the cell being overshooting comprises an automated service ticket.

14. An apparatus comprising:
at least one processor; and at least one memory including computer program code; the at least one memory and the computer code configured to, with the at least one processor, cause the apparatus at least to:
estimate a dominance area of a cell of a communication network;
identify a plurality of devices transferring data via the cell, wherein the plurality of devices are substantially stationary outside the dominance area of the cell and primarily use at least one other cell of the communication network for data transfer;
determine that the cell is overshooting based on at least one of:
a number of the plurality of devices.
distances of the plurality of devices to an access node of the cell, or
a number of intervening cells overlapping in frequency with the cell and being located between the access node of the cell and the plurality of devices; and
outputting an indication of the cell being overshooting.

15. A computer program comprising program code configured to, when executed by a processor, cause the an apparatus at least to:
estimate a dominance area of a cell of a communication network;
identify a plurality of devices transferring data via the cell, wherein the plurality of devices are substantially stationary outside the dominance area of the cell and primarily use at least one other cell of the communication network for data transfer;
determine that the cell is overshooting based on at least one of:
a number of the plurality of devices,
distances of the plurality of devices to an access node of the cell, or
a number of intervening cells overlapping in frequency with the cell and being located between the access node of the cell and the plurality of devices; and
outputting an indication of the cell being overshooting.
